(19) United States
(12) Patent Application Publication
(10) Pub. No.: US 2010/0109523 A1
(43) Pub. Date: May 6, 2010

(54) DIELECTRIC COMPOSITION AND PLASMA DISPLAY PANEL INCLUDING THE SAME

(75) Inventors: Woong Choi, Cheongju-si (KR); Taejung Kim, Cheongju-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/532,980

(22) PCT Filed: Dec. 6, 2007
(86) PCT No.: PCT/KR2007/006329

§ 371 Date: Sep. 24, 2009

(30) Foreign Application Priority Data
Apr. 4, 2007 (KR) 10-2007-0033128

(51) Int. Cl. H01J 17/49; C03C 3/04

(52) U.S. Cl. 313/582; 501/53

(57) ABSTRACT

A dielectric composition for plasma display panel and a plasma display panel including the same are disclosed. The dielectric composition includes about 3 to 10 parts by weight of SiO2, about 13 to 35 parts by weight of B2O3, about 25 to 48 parts by weight of ZnO, and about 10 to 20 parts by weight of BaO.

### TECHNICAL FIELD

An exemplary embodiment of the present invention relates to a display apparatus, and more particularly, to a dielectric composition for plasma display panel and a plasma display panel including the same.

### BACKGROUND ART

Out of display apparatuses, a plasma display apparatus generally includes a plasma display panel displaying an image and a driver for driving the plasma display panel.

The plasma display panel has the structure in which an upper dielectric layer and a lower dielectric layer respectively formed on a front substrate and a rear substrate and barrier ribs formed between the front substrate and the rear substrate form unit discharge cell or discharge cells. Each discharge cell is filled with an inert gas containing a main discharge gas such as neon (Ne), helium (He) or a mixture of Ne and He, and a small amount of xenon (Xe).

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and large and also can provide the greatly improved image quality by the recently technological development, it has attracted attention as a next generation display device.

The upper dielectric layer and the lower dielectric layer limit a discharge current during the generation of a plasma discharge, maintain a glow discharge, and perform a memory function for accumulating wall charges and a voltage reduction function. The dielectric layers may be formed by forming a dielectric formation material of a paste form obtained by mixing and kneading a powder such as a glass powder and an additive using a screen printing method and by firing it.

Because a transmittance of the upper dielectric layer formed on the front substrate has to be good to transmit visible light emitted from the phosphor of the plasma display panel, the upper dielectric layer is formed of a transparent dielectric composition.

Further, the upper dielectric layer has to stand a driving voltage applied to the plasma display panel, and must not adversely affect the plasma display panel during the generation of a discharge. Accordingly, because a permittivity among electrical characteristics required in the dielectric composition for forming the upper dielectric layer directly affects the power efficiency of the plasma display panel, the permittivity of the dielectric composition is more important.

### DISCLOSURE OF INVENTION

### Technical Problem

As the permittivity of the dielectric composition decreases, the power efficiency of the plasma display panel improves. Bi used to form the upper dielectric layer show a characteristic of a low melting point, but is well known as a material capable of increasing a permittivity. Therefore, when the dielectric composition includes Bi, the power efficiency of the plasma display panel is reduced.

A paste obtained by mixing a glass powder containing PbO with an organic material is mainly used to form the dielectric layer. However, it is known that PbO is harmful to the human body and the environment. Accordingly, an additional environment equipment is necessary to manufacture and use the glass powder, thereby reducing the process efficiency and increasing the manufacturing cost.

A glass composition containing a large amount of PbO has been used in the application of electronic parts over a long period of time. The glass composition containing PbO has been widely used in the electronic parts because of its high refraction index and low melting point. However, the use of PbO causing environmental problems has been on the use as a problem which has to be urgently solved.

### Technical Solution

An exemplary embodiment of the present invention provides an environmentally-friendly plasma display panel capable of improving power efficiency using a dielectric composition not including PbO and Bi.

A dielectric composition for a plasma display panel comprises about 3 to 10 parts by weight of SiO2, about 13 to 35 parts by weight of B2O3, about 25 to 48 parts by weight of ZnO, and about 10 to 20 parts by weight of BaO.

The dielectric composition may further comprise P2O5.

A content of P2O5 may be more than 0 and equal to or less than 23 parts by weight.

A plasma display panel comprises a front substrate, a rear substrate opposite to the front substrate, and a dielectric layer that is positioned on the front substrate or the rear substrate and is formed of a dielectric composition, the dielectric composition comprising about 3 to 10 parts by weight of SiO2, about 13 to 35 parts by weight of B2O3, about 25 to 48 parts by weight of ZnO, and about 10 to 20 parts by weight of BaO.

The dielectric composition may further comprise P2O5.

A content of P2O5 may be more than 0 and equal to or less than 23 parts by weight.

The dielectric layer may substantially have a glass softening temperature of 543 to 605° C.

The dielectric layer may substantially have a glass transition temperature of 520 to 556° C.

The dielectric layer may substantially have a permittivity of 7 to 9 C2/Nm².

The dielectric layer may substantially have a transmittance of 57 to 73%.

The dielectric layer may be substantially transparent.

### Advantageous Effects

As described above, since the plasma display panel according to an exemplary embodiment includes the dielectric layer not including PbO, the environmentally-friendly plasma display panel having the similar characteristics to the dielectric layer including PbO can be provided.

Further, since the dielectric layer according to an exemplary embodiment has the permittivity lower than the permittivity of the dielectric layer including PbO and Bi, the plasma display panel having the excellent power efficiency can be provided.

### BRIEF DESCRIPTION OF THE DRAWINGS

FIG. 1 illustrates a plasma display panel according to an exemplary embodiment of the present invention.

### BEST MODE FOR CARRYING OUT THE INVENTION

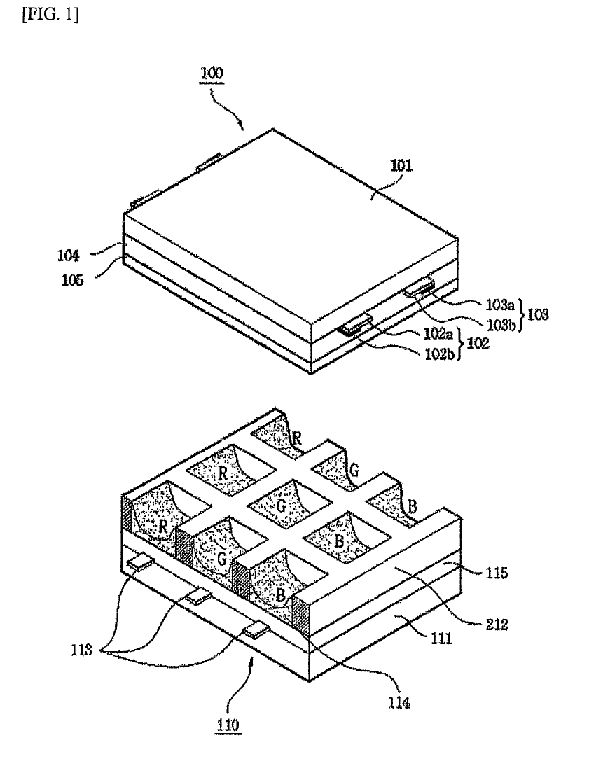

FIG. 1 illustrates a plasma display panel according to an exemplary embodiment of the present invention.

As illustrated in FIG. 1, the plasma display panel includes a front panel 100 and a rear panel 110 which are positioned parallel to each other at a given distance therebetween. The front panel 100 includes a front substrate 101 on which a plurality of scan electrodes 102 and a plurality of sustain electrodes 103 are formed. The rear panel 110 includes a rear substrate 111 on which a plurality of address electrodes 113 are formed to intersect the scan electrodes 102 and the sustain electrodes 103.

The scan electrode 102 and the sustain electrode 103 generate a mutual discharge therebetween in one discharge cell and maintain light-emissions of discharge cells. More specifically, the scan electrode 102 and the sustain electrode 103 may each includes transparent electrodes 102a and 103a made of a transparent indium-tin-oxide (ITO) material and bus electrodes 102b and 103b made of an opaque metal material.

The scan electrode 102 and the sustain electrode 103 are covered with one or more upper dielectric layers 104 for limiting a discharge current and providing insulation between the scan electrode 102 and the sustain electrode 103. The dielectric layers 104 may be substantially transparent. A protective layer 105 with a deposit of MgO may be positioned on the upper dielectric layer 104 to facilitate discharge conditions.

The rear panel 110 includes a plurality of stripe-type or well-type barrier ribs 112 for partitioning a plurality of discharge spaces (i.e., a plurality of discharge cells).

Red (R), green (G) and blue (B) phosphors 114 for emitting visible light for an image display cluing the generation of an address discharge are positioned inside the discharge cells partitioned by the barrier ribs 112.

A lower dielectric layer 115 is formed between the address electrodes 113 and the phosphors 114 to protect the address electrodes 113.

An exemplary embodiment of the present invention described the case where the transparent upper dielectric layer 104 and the lower dielectric layer 115 are formed on the front substrate 101 and the rear substrate 111, respectively. However, an exemplary embodiment of the present invention is not limited thereto. On the contrary, the upper dielectric layer 104 and the lower dielectric layer 115 may be formed on the rear substrate 111 and the front substrate 101, respectively.

FIG. 1 illustrated only an example of the plasma display panel, and thus an exemplary embodiment of the present invention is not limited to the structure of the plasma display panel illustrated in FIG. 1. The plasma display panel illustrated in FIG. 1 includes the scan electrode 102, the sustain electrode 103 and the address electrode 113. However, at least one of the scan electrode 102, the sustain electrode 103 or the address electrode 113 may be omitted.

In the plasma display panel according to an exemplary embodiment of the present invention, the upper dielectric layer 104 and the lower dielectric layer 115 are formed on the front substrate 101 and the rear substrate 111, respectively, and the upper dielectric layer 104 does not include PbO and Bi and can be formed using various dielectric materials. In other words, the plasma display panel can be variously changed except the above-described conditions.

The dielectric composition for the plasma display panel according to an exemplary embodiment will be described below.

A dielectric composition for the plasma display panel according to an exemplary embodiment of the present invention maintains a glow discharge and accumulates wall charges. The dielectric composition does not include PbO and Bi, and is a lead-free glass composition including SiO2, B2O3, ZnO, and BaO as a principal component.

The dielectric composition for the plasma display panel may be substantially transparent. The dielectric composition includes SiO2, B2O3, ZnO and BaO, and may further include P2O5.

The dielectric composition may include about 3 to 10 parts by weight of SiO2. SiO2, which is a glass former, chemically and optically stabilizes a glass, and greatly raise a glass transition temperature and a glass softening temperature of the dielectric composition.

When a content of SiO2 is equal to or more than 3 part by weight, SiO2 can chemically and optically stabilize the dielectric composition. When a content of B2O3 is equal to or less than 10 parts by weight, SiO2 can prevent an excessive rise in the glass transition temperature.

The dielectric composition may include about 13 to 35 parts by weight of B2O3. B2O3 forms a network structure of the dielectric composition.

When a content of B2O3 is equal to or more than 13 parts by weight, the network structure of the dielectric composition can be fully formed. When a content of B2O3 is equal to or less than 35 parts by weight, B2O3 can prevent a use in the glass transition temperature of the dielectric composition.

The dielectric composition may include about 25 to 48 parts by weight of ZnO. ZnO lowers the glass transition temperature and the glass softening temperature of the dielectric composition.

When a content of ZnO is equal to or more than 25 parts by weight, ZnO can sufficiently lower the glass transition temperature and the glass softening temperature.

When a content of ZnO is equal to or less than 48 parts by weight, ZnO can prevent a glass crystallization which is likely to be formed by the dielectric composition.

The dielectric composition may include about 10 to 20 parts by weight of BaO. BaO adjusts a permittivity and a thermal expansion coefficient of the dielectric composition.

When a content of BaO is equal to or more than 10 parts by weight, the dielectric composition in which a permittivity and a thermal expansion coefficient are stabilized can be obtained. When a content of BaO is equal to or less than 20 parts by weight, BaO can prevent a reduction in the form stability of the dielectric composition caused by an increase in the thermal expansion coefficient.

The dielectric composition may further include P2O5. A content of P2O5 may be more than 0 and equal to or less than 23 parts by weight. P2O5 is a glass former of a light color, and slightly raise the glass transition temperature of the dielectric composition. Further, P2O5 reduces the permittivity of the dielectric composition, and slightly reduces a gelation level of the dielectric composition.

When a content of P2O5 is more than 0, P2O5 can reduce the permittivity. When a content of P2O5 is equal to or less than 10 parts by weight, P2O5 can prevent a sharp rise in the glass transition temperature.

A method of manufacturing a dielectric powder using the dielectric composition for the plasma display panel will be described below.

The dielectric powder can be manufactured using general manufacturing processes of a glass powder. First, about 3 to 10 parts by weight of SiO2, about 13 to 35 parts by weight of B2O3, about 25 to 48 parts by weight of ZnO, about 10 to 20 parts by weight of BaO, and P2O5 more than 0 and equal to ore less than 23 parts by weight are provided, and are mixed with one another. Then, the mixture is melted at a temperature of 1000-1,500° C. for 10-60 minutes, and this can uniformly mixed in a melting state.

The melted mixture is quickly frozen in a dry manner or a wet manner, and water may be used in the wet manner. Then, the quickly frozen mixture is ground in a dry manner or a wet manner. Water or an organic solvent may be used in the wet manner. Examples of the organic solvent include ethanol, methanol, ethyl acetate, toluene or isopropyl alcohol.

Water or the organic solvent may be used independently, and may be mixed with each other to form a dielectric powder. A gelation level of the dielectric powder and a color of the dielectric powder after firing the dielectric powder can be controlled depending on kinds of the organic solvent.

The ground dielectric powder is filtered, dried, and disintegrated to manufacture a powder having a small grain diameter, for instance, a diameter of 0.1-10 μm.

A method of manufacturing a dielectric paste using the dielectric powder thus manufactured will be described below.

A dielectric paste is coated on the front substrate 101 of the plasma display panel, on which the scan electrode 102 and the sustain electrode 103 are formed, as high as 10-15 μm.

The dielectric paste is formed by mixing the dielectric powder, a binder and an organic solvent. The dielectric powder, as described above, is obtained by mixing, melting, quickly freezing, filtering, drying and disintegrating the dielectric composition including about 3 to 10 parts by weight of SiO2, about 13 to 35 parts by weight of B2O3, about 25 to 48 parts by weight of ZnO, about 10 to 20 parts by weight of BaO, and P2O5 more than 0 and equal to ore less than 23 parts by weight.

A general binder used to manufacture the dielectric layer may be used as the binder.

For instance, at least one polymer resin of acrylic-based resin, epoxy-based resin, or ethyl cellulose-based resin may be used.

A general organic solvent used to manufacture the dielectric layer may be used as the organic solvent. For instance, at least one of butyl cellosolve (BC), butyl carbitol acetate (BCA), terpineol (TP) or texanol may be used.

In addition, a filler may be further added to the dielectric paste. For instance, CrO, CuO, MgO, Al2O3, ZnO, TiO2, 3Al2O3SiO2 may be used.

### Mode for the Invention

### Experimental Example 1

SiO2 of 10 g, B2O3 of 17 g, ZnO of 48 g, BaO of 20 g, and P2O5 of 25.7 g were mixed with one another, and the mixture was melted in a furnace at 1200° C. The melted mixture was quickly dry-frozen, and then ground to form a dielectric powder.

The dielectric powder of 94 g, ethyl cellulose of 3 g and butyl carbitol acetate (BCA) of 3 g were mixed to manufacture a dielectric paste.

The dielectric paste was screen-printed on a front substrate, on which a scan electrode and a sustain electrode are formed, as high as 10-15 μm, and then dried.

The dried dielectric paste was fired at 500° C. to form a dielectric layer.

### Experimental Example 2

A dielectric layer of the experimental example 2 was manufactured under the same condition as the above experimental example 1, except a dielectric composition forming a dielectric powder. The dielectric composition included SiO2 of 8.4 g, B2O3 of 22.78 g, ZnO of 43.38 g, BaO of 17.73 g, and P2O5 of 7.73 g.

### Experimental Example 3

A dielectric layer of the experimental example 3 was manufactured under the same condition as the above experimental example 1, except a dielectric composition forming a dielectric powder. The dielectric composition included SiO2 of 5.9 g, B2O3 of 22.78 g, ZnO of 45.88 g, BaO of 17.73 g, and P2O5 of 7.73 g.

### Experimental Example 4

A dielectric layer of the experimental example 4 was manufactured under the same condition as the above experimental example 1, except a dielectric composition forming a dielectric powder. The dielectric composition included SiO2 of 5 g, B2O3 of 17 g, ZnO of 48 g, BaO of 20 g, and P2O5 of 25.7 g.

### Experimental Example 5

A dielectric layer of the experimental example 5 was manufactured under the same condition as the above experimental example 1, except a dielectric composition forming a dielectric powder. The dielectric composition included SiO2 of 3 g, B2O3 of 35 g, ZnO of 32 g, BaO of 20 g, and P2O5 of 10 g.

### Experimental Example 6

A dielectric layer of the experimental example 6 was manufactured under the same condition as the above experimental example 1, except a dielectric composition forming a dielectric powder. The dielectric composition included SiO2 of 3 g, B2O3 of 28 g, ZnO of 48 g, and BaO of 20 g.

### Comparative Example

A dielectric layer of the comparative example was manufactured using a marketing mother glass including PbO under the same condition as the above experimental example 1.

A glass transition temperature, a glass softening temperature, a transmittance, and a permittivity of each of the dielectric layers of the experimental examples 1 to 6 and the comparative example were measured and indicated in the following table 1.

TABLE 1

| Glass softening | | |
|---|---|---|
| temperature(° C.) | Transmittance(%) | Permittivity(C2/Nm²) |
| 566 | 65 | 9 |
| 573 | 58 | 7 |
| 563 | 57 | 8 |
| 555 | 60 | 9 |
| 605 | 73 | 6 |
| 543 | 63 | 9 |
| 480 | 65 | 12 |

As indicated in the above table 1, the dielectric layer of the plasma display panel according to an exemplary embodiment in the experimental examples 1 to 6 had a glass transition temperature of 520-556° C., a glass softening temperature of 543-605° C., a transmittance of 57-73%, and a permittivity of 6-9 C2/Nm² .

Accordingly, the dielectric layers of the experimental examples 1 to 6 had a similar thermal characteristic (i.e., the glass transition temperature and the glass softening temperature) and a similar transmittance to the dielectric layer of the comparative example including PbO. Further, the dielectric layer of the experimental examples 1 to 6 had the permittivity lower than the permittivity of the dielectric layer of the comparative example including Bi.

1. A dielectric composition for a plasma display panel comprising:
about 3 to 10 parts by weight of SiO2;
about 13 to 35 parts by weight of B2O3;
about 25 to 48 parts by weight of ZnO; and
about 10 to 20 parts by weight of BaO.

2. The dielectric composition of claim 1, further comprising P2O5.

3. The dielectric composition of claim 2, wherein a content of P2O5 is more than 0 and equal to or less than 23 parts by weight.

4. A plasma display panel comprising:
a front substrate;
a rear substrate opposite to the front substrate; and
a dielectric layer that is positioned on the front substrate or the rear substrate and is formed of a dielectric composition, the dielectric composition comprising:
about 3 to 10 parts by weight of SiO2;
about 13 to 35 parts by weight of B2O3;
about 25 to 48 parts by weight of ZnO; and
about 10 to 20 parts by weight of BaO.

5. The plasma display panel of claim 4, the dielectric composition further comprises P2O5.

6. The plasma display panel of claim 5, wherein a content of P2O5 is more than 0 and equal to or less than 23 parts by weight.

7. The plasma display panel of claim 4, wherein the dielectric layer substantially has a glass softening temperature of 543 to 605° C.

8. The plasma display panel of claim 4, wherein the dielectric layer substantially has a glass transition temperature of 520 to 556° C.

9. The plasma display panel of claim 4, wherein the dielectric layer substantially has a permittivity of 7 to 9 C2/Nm².

10. The plasma display panel of claim 4, wherein the dielectric layer substantially has a transmittance of 57 to 73%.

11. The plasma display panel of claim 4, wherein the dielectric layer is substantially transparent.
